(19) United States
(12) Patent Application Publication
(10) Pub. No.: US 2025/0349487 A1
(43) Pub. Date: Nov. 13, 2025

(54) X-RAY SOURCE

(71) Applicants: VATECH Co., Ltd., Gyeonggi-do (KR); VATECH EWOO Holdings Co., Ltd., Gyeonggi-do (KR)

(72) Inventors: Jung Su KANG, Gyeonggi-do (KR); Kun Hwan KIM, Gyeonggi-do (KR); Yang Doo LEE, Gyeonggi-do (KR)

(73) Assignees: VATECH Co., Ltd., Gyeonggi-do (KR); VATECH EWOO Holdings Co., Ltd., Gyeonggi-do (KR)

(21) Appl. No.: 18/707,841

(22) PCT Filed: Nov. 4, 2022
(86) PCT No.: PCT/KR2022/017188

§ 371 Date: May 6, 2024

(30) Foreign Application Priority Data
Nov. 4, 2021 (KR) 10-2021-0150643

(51) Int. Cl. H01J 35/12; H01J 35/06

(52) U.S. Cl. CPC H01J 35/12; H01J 35/06; H01J 2235/167

(57) ABSTRACT

The present invention provides an X-ray source comprising: an anode electrode on which a target is formed; a tubular-shaped first housing which is made of an insulating material and at one end of which the anode electrode is provided; a tubular-shaped second housing which is made of a conductive material and one end of which is connected to the first housing; and a cathode electrode which is provided at the other end of the second housing and has an emitter formed opposite to the target.

### TECHNICAL FIELD

The present invention relates to a field emission-type X-ray source.

### BACKGROUND ART

In general, X-ray sources are being widely used in various inspection devices or diagnostic devices for medical diagnosis, non-destructive testing, or chemical analysis.

A field emission-type X-ray source is provided with a cathode electrode, a gate electrode, and an anode electrode in a vacuum housing made of an insulating material such as ceramic. An emitter formed of nanostructures such as CNTs (Carbon Nano Tubes) is provided on one side of the cathode electrode, and a target such as tungsten (W) is provided on one side of the anode electrode opposite to the cathode electrode. Herein, a gate electrode is provided between the emitter and the target. The field emission X-ray source is configured to generate X-rays by causing electrons to be emitted from the emitter by the gate voltage applied to the gate electrode and causing the emitted electrons to be accelerated toward the anode electrode and then collided with the target due to a voltage difference between the cathode voltage and anode voltage that are applied to the cathode electrode and the anode electrode, respectively.

However, because the housing in the existing field emission-type X-ray source is made of an insulating material such as ceramic, when the residual charge is trapped, it is difficult to remove it, whereby the emitter of the nanostructure may deteriorate when arc discharges occur.

### PRIOR ART DOCUMENT

### Patent Document

[Patent Document 1] Korean Patent Application Publication No. 10-2021-0083040

### DISCLOSURE

### Technical Problem

The present invention has been made keeping in mind the above problems occurring in the related art, and an objective of the present invention is to provide a field emission-type X-ray source that is configured to join the first housing on a side of the anode electrode made of ceramic material and the second housing on a side of the cathode electrode made of metal material that are included as a housing of the field emission-type X-ray source, thereby easily introducing residual charges in the housing into the second housing made of metal material to cause them to be dissipated.

### Technical Solution

In order to achieve the above objectives, an X-ray source according to the present invention includes an anode electrode; a target electrically connected to the anode electrode; a first housing of an insulating material accommodating at least a part of the anode electrode; an emitter formed opposite to the target; a cathode electrode electrically connected to the emitter; and a second housing of a conductive material forming an X-ray tube together with the first housing.

In addition, the first housing may have a larger inner diameter as it moves from the anode electrode to the cathode electrode.

In addition, the X-ray source may further include a flange provided on an outer surface of the second housing; and a window formed on the flange.

In addition, the second housing may further include an insulating spacer; and the cathode electrode may be fixed to the insulating spacer.

In addition, the cathode electrode may be disposed inside or outside the second housing.

In addition, the size of the anode voltage applied to the anode electrode may be proportional to the length of the first housing.

### Advantageous Effects

The X-ray source of the present invention has the following effects.

The present invention can have an advantage of preventing deterioration of the emitter due to discharge arc, by configuring the housing in such a manner as to join a first housing on a side of the anode electrode made of a ceramic material and a second housing on a side of the cathode electrode made of a metal material, to minimize the possibility of charge remaining in the first housing through the characteristic of joining structure of the first and second housings, as well as to quickly remove residual charges by grounding the second housing.

In addition, a window is provided in a flange portion provided on a side of the second housing corresponding to the position on which X-rays are incident, thereby providing convenience in connecting and aligning with other devices.

### DESCRIPTION OF DRAWINGS

FIG. 1 is an external perspective view of an X-ray source according to a first embodiment of the present invention.

FIG. 2 is a longitudinal cross-sectional view of FIG. 1.

FIGS. 3, 4 and 5 are enlarged cross-sectional views of parts A, B and C of FIG. 2.

FIG. 6 is an external perspective view of an X-ray source according to a second embodiment of the present invention.

FIG. 7 is a longitudinal cross-sectional view of FIG. 6.

FIG. 8 is an enlarged cross-sectional view of a part D of FIG. 7.

### BEST MODE

Hereinafter, embodiments disclosed in the present specification will be described in detail with reference to the attached drawings, in which identical or similar components will be assigned the same reference numerals in all the drawings, and duplicate descriptions thereof will be omitted. The suffixes “module” and “part” for components used in the following description are given or used interchangeably only for the ease of preparing the specification, and do not have distinct meanings or roles in themselves. Additionally, in describing the embodiments disclosed herein, when it is determined that a detailed description of related known technologies may obscure the gist of the embodiments disclosed herein, the detailed description will be omitted. In addition, while the attached drawings are only for easy understanding of the embodiments disclosed herein, it should be understood that the technical idea disclosed herein is not limited by the attached drawings, but includes all changes, equivalents, and substitutes included in the spirit and technical scope of the present invention.

Terms containing ordinal numbers, such as first, second, etc., may be used to describe various components, but the components are not limited by the terms. The terms are used only for the purpose of distinguishing one component from another.

It should be understood that when a component is referred to as being “connected to” or “coupled to” another component, it can be directly connected or coupled to another component, or intervening components may be present. In contrast, it should be understood that when a component is referred to as being “directly connected to” or “directly coupled to” another component, no intervening components are present.

The singular forms are intended to include the plural forms as well, unless the context clearly indicates otherwise.

Herein, it should be understood that terms such as “comprise” or “have” are intended to designate the presence of features, numbers, steps, operations, components, parts, or combinations thereof described in the specification, and does not exclude in advance the presence or addition of one or more features, numbers, other steps, operations, components, parts, or combinations thereof.

In the drawings, the sizes of components may be exaggerated or reduced for illustrative purpose only. For example, since the size and thickness of each component shown in the drawings are arbitrarily indicated for illustrative purpose only, the present invention is not necessarily limited to this.

In cases where an embodiment can be implemented differently, a specific process sequence may be performed differently from the described sequence. For example, two processes described in sequence may be performed substantially at the same time, or may be performed in an order opposite to the order in which they are described.

Since the present invention can be divided into several embodiments depending on the specific configuration and operation, each embodiment will be examined separately hereinafter. For convenience of explanation, common contents for each embodiment will be sufficiently explained in the first embodiment, and the differences will be mainly explained regarding other embodiments.

### First Embodiment

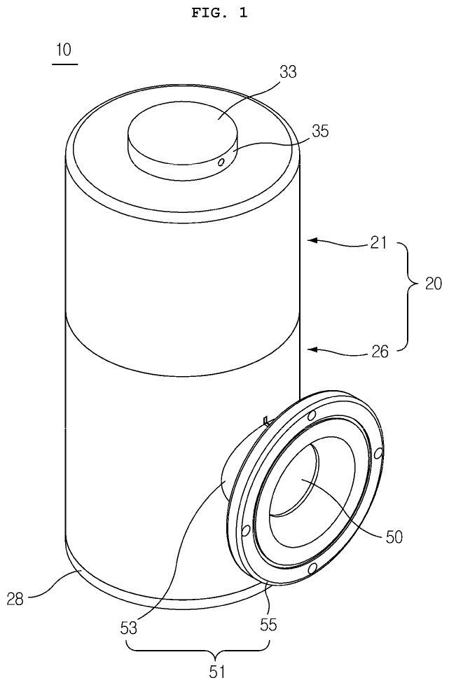

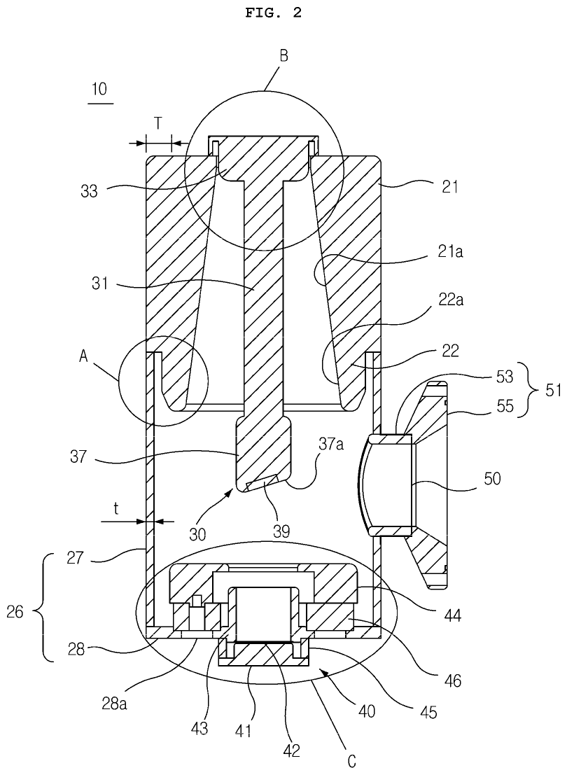

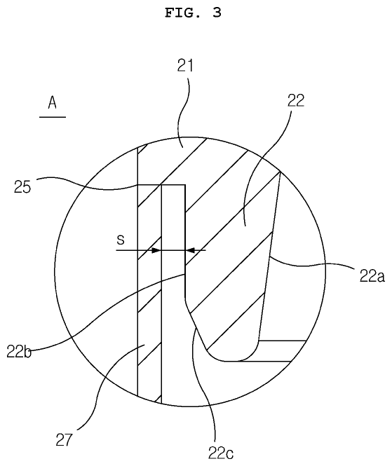

FIG. 1 is an external perspective view of an X-ray source according to a first embodiment of the present invention; FIG. 2 is a longitudinal cross-sectional view of FIG. 1; and FIGS. 3, 4 and 5 are enlarged cross-sectional views of parts A, B and C of FIG. 2.

Referring to FIGS. 1 and 2, the X-ray source 10 may include a housing 20 which forms an external appearance.

The housing 20 has a hollow tube shape in which vacuum is created.

The housing 20 may include a first housing 21 with an anode electrode portion 30.

The first housing 21 may have a hollow shape. The first housing 21 may be made of an insulating material. For example, the first housing 21 may be made of ceramic material.

An inner surface 21a of the first housing 21 may have a skirt shape. The skirt shape may have a larger inner diameter, as it descends from top to bottom, that is, moves from the anode electrode portion 30 to a cathode electrode portion 40, which will be described later.

Referring to FIGS. 2 and 3, the first housing 21 may include a sleeve 22. The sleeve 22 may be formed to extend downward from the lower end of the first housing 21 facing the cathode electrode portion 40 toward the cathode electrode portion 40 through the inside of a cylindrical tube 27. Therefore, the sleeve 22 may cover a joint portion 25 of joining the lower end of the first housing 21 and the upper end of the cylindrical tube 27. The sleeve 22 may be integrated with the first housing 21. The inner surface 22a of the sleeve 22 may have a rib shape extending downward from the inner surface 21a of the first housing 21. Such a rib shape may secure the maximum insulation distance. The outer surface 22b of the sleeve 22 may be spaced apart from the cylindrical tube 27. An inclined surface 22c may be formed outside the lower end of the sleeve 22. The inclined surface 22c may have a funnel or dish shape whose distance from the inner surface of the cylindrical tube 27 gradually narrows as it approaches the first housing 21. Such a funnel or dish shape may smoothly introduce electric charges remaining in the internal space of the housing 20 to the second housing 26 that is on the metal side.

The housing 20 may include a second housing 26 with the cathode electrode portion 40. The second housing 26 may be made of metal material. The second housing 26 may be grounded.

The second housing 26 may include a cylindrical tube 27 that is made of metal. The upper end of the cylindrical tube 27 may be joined to the lower end of the first housing 21. Herein, the joining may be brazing welding, for example.

The second housing 26 may include a bottom plate 28 that is made of metal. The bottom plate 28 may be a hollow plate that is donut-shaped. For example, a through hole 28a may be formed in the center of the bottom plate 28. The edge of the bottom plate 28 may be joined to the lower end of the cylindrical tube 27. The joining may be brazing welding, for example.

Referring to FIG. 2, the average thickness T of the first housing 21 may be formed to be much thicker than the thickness t of the second housing 26. This is to prevent the insulation of the ceramic material of the first housing 21 from being destroyed due to the high voltage applied to the anode electrode portion 30.

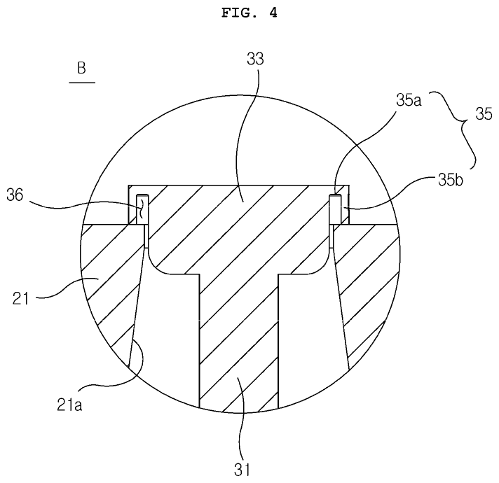

Referring to FIGS. 2 and 4, the X-ray source 10 may include an anode electrode portion 30 provided at one end of the first housing 21.

The anode electrode portion 30 may include an anode electrode 31 disposed at the center of the inner surface of the first housing 21. The anode electrode 31 may be made of metal.

The anode electrode portion 30 may include a support bundle 33 disposed outside the top of the first housing 21. The support bundle 33 may be made of metal. The support bundle 33 may be formed integrally with the top of the anode electrode 31. The diameter of the support bundle 33 may be larger than the diameter of the anode electrode 31 and smaller than the minimum inner diameter of the first housing 21. The support bundle 33 may include a support 35 made of metal. The support 35 may be formed on the outer peripheral surface of the support bundle 33. The support 35 may have an L-shaped bridge structure. The support 35 may include a horizontal support 35a. The horizontal support 35a may protrude horizontally outward from the outer peripheral surface of the support bundle 33. The support 35 may include The vertical support 35b may a vertical support 35b. protrude downward from the horizontal support 35a. The lower end of the vertical support 35b may be joined to the upper end of the first housing 21. A space 36 may be formed between the vertical support 35b and the outer peripheral surface of the support bundle 33. The support 35 and the space 36 may allow the anode electrode portion 30 to be stably fixed to the first housing 21, despite the difference in thermal expansion coefficient between dissimilar materials of the anode electrode portion 30 made of metal and the first housing 21 made of ceramic.

The anode electrode portion 30 may include a target installation bundle 37 made of metal. The target installation bundle 37 may be formed integrally with the lower end of the anode electrode 31. The lower surface 37a of the target installation bundle 37 is inclined diagonally toward the window 50. The target 39 may be bonded to the lower surface 37a of the target installation bundle 37. The target 39 may emit X-rays to the window 50 by hitting accelerated electrons. The target 39 may be made of tungsten (w), copper (Cu), molybdenum (Mo), cobalt (Co), chromium (Cr), iron (Fe), silver (Ag), tantalum (Ta), yttrium (Y), and the like. For example, tungsten (w), which has a high melting point and excellent X-ray emission efficiency, may be used as the target 39.

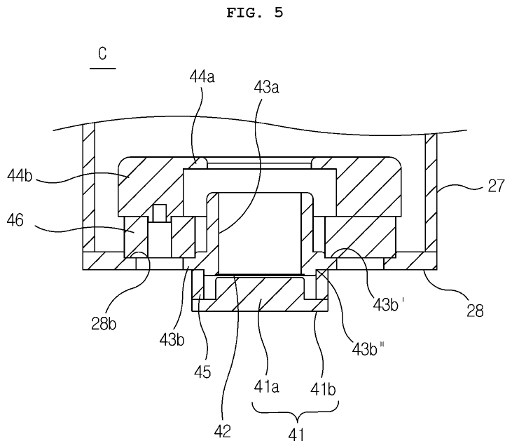

Referring to FIGS. 2 and 5, the X-ray source 10 may include a cathode electrode portion 40. The cathode electrode portion 40 may be disposed in the through hole 28a of the bottom plate 28 of the second housing 26 to be spaced apart from the through hole 28a. As a result, the cathode electrode portion 40 may be electrically insulated from the second housing 26 made of metal.

The cathode electrode portion 40 may include a cathode electrode 41. The cathode electrode 41 may be disposed outside the bottom plate 28 of the second housing 26.

The cathode electrode 41 may have a convex shape. The cathode electrode 41 may include a cathode body 41a made of metal. A nanoscale emitter (not shown), such as CNTs (Carbon Nanotubes) and a metal nanotips may be disposed on the surface of the cathode body 41a.

The cathode electrode 41 may include a cathode flange 41b made of metal. The cathode flange 41b may be formed integrally with the lower side of the cathode body 41a.

The cathode electrode portion 40 may include a gate electrode 42. The gate electrode 42 may be provided to be spaced apart from the upper surface of the cathode body 41a. As a result, the gate electrode 42 is electrically insulated from the cathode electrode 41. The gate electrode 42 may be mesh-shaped.

The gate electrode 42 may include a focus portion 43. The focus portion 43 may include a focus tube 43a. The gate electrode 42 may be bonded to the lower end of the focus tube 43a. The focus tube 43a may allow electrons emitted from the emitter and passing through the gate electrode 42 to be focused. The focus portion 43 may include a focus flange 43b. The focus flange 43b may be formed on the lower side of the focus tube 43a. A first step 43b′ may be formed on the upper surface of the focus flange 43b. The first step 43b′ may be formed to be concave downward. A second step 43b″ may be formed on the lower surface of the focus flange 43b. The second step 43b″ may be formed to be concave upward.

The cathode electrode portion 40 may include a focus electrode 44. The focus electrode 44 may perform secondary focusing on the electrons focused in the focus portion 43.

The focus electrode 44 may include a focus electrode hollow plate 44a. The inner diameter of the focus electrode hollow plate 44a may be the same as or slightly larger than that of the focus tube 43a.

The focus electrode 44 may include a focus electrode side wall 44b. The focus electrode side wall 44b may extend downward from the lower edge of the focus electrode hollow plate 44a. The inner diameter of the focus electrode side wall 44b may be approximately the same as the outer diameter of the focus flange 43b.

The cathode electrode portion 40 may include a first insulating spacer 45 in a tube shape. The first insulating spacer 45 may be provided between the cathode electrode 41 and the focus portion 43. That is, the first insulating spacer 45 may be provided between the cathode flange 41b and the second step 43b″. The first insulating spacer 45 may separate the cathode electrode 41 and the gate electrode 42 from each other to cause them to be electrically insulated.

The cathode electrode portion 40 may include a second insulating spacer 46 in a tube shape. The second insulating spacer 46 may be provided between the focus electrode 44 and the bottom plate 28 of the second housing 26 and between the focus electrode 44 and the focus portion 43. That is, the bottom of the second insulating spacer 46 is placed on the first step 43b′ and the step 28b of the bottom plate 28, such that the upper surface of the second insulating spacer 46 may support the focus electrode side wall 44b. The second insulating spacer 46 may separate the focus portion 43 and the focus electrode 44 of the gate electrode 42 while simultaneously fixing the cathode electrode portion 40 to the second housing 26. As a result, the gate electrode 42 and the focus electrode 44 may be electrically insulated from each other.

The cathode electrode portion 40 may be joined to these components to form an assembly. The cathode electrode portion 40 of such an assembly structure may be joined to the second housing 26 by pillar-welding the second insulating spacer 46 and the step 28b of the bottom plate 28.

The X-ray source 10 may include a window 50. The window 50 may be provided inside the flange portion 51 provided on one side of the cylindrical tube 27 of the second housing 26 facing the target 39.

The flange portion 51 may include a horizontal pipe 53. The horizontal pipe 53 may be provided on one outer surface of the cylindrical tube 27.

The flange portion 51 may include a flange 55. The flange 55 may be provided at the end of the horizontal pipe 53.

The window 50 may be provided at the interface between the horizontal pipe 53 and the flange 55.

This flange portion 51 may not only allow the window 50 to be provided, but also provide convenience in connectivity and alignment with other devices.

A cathode voltage may be applied to the cathode electrode 41, an anode voltage may be applied to the anode electrode portion 30, a gate voltage may be applied to the gate electrode 42, and a focus voltage may be applied to the focus electrode 44. When electrons are emitted from the emitter by the gate voltage applied to the gate electrode 42, due to the high potential difference between the cathode voltage and anode voltage that are applied to the cathode electrode 41 and the anode electrode portion 30, respectively, the electrons pass through the mesh of the gate electrode 42, accelerate toward the anode electrode portion 30, and then collide with the target 39, thereby generating X-rays. The generated X-rays pass through the window 50 to be emitted to the outside. In this process, the focus electrode 44 focuses the electrons passing through the mesh of the gate electrode 42 and moving toward the anode electrode portion 30 onto the target 39. Meanwhile, the distance between the target 39 and the cathode electrode 41 may be fixed to form an electric field.

The X-ray source 10 according to the first modification of this embodiment is configured in a so-called single power supply manner in which a cathode voltage applied to the cathode electrode represents a ground potential and an anode voltage applied to the anode electrode portion 30 represents a positive potential. Here, a high voltage of a very high potential is applied to the anode electrode portion 30. The anode voltage may be above +120 kV, for example. Therefore, the insulation of the first housing 21 is strengthened by increasing the length of the anode electrode 31 and the first housing 21, and the cathode electrode 41 is placed outside the lower end of the second housing 20 by adjusting the height of the second insulating spacer 46, thereby maintaining the distance between the target 39 and the cathode electrode 41.

### Second Modification

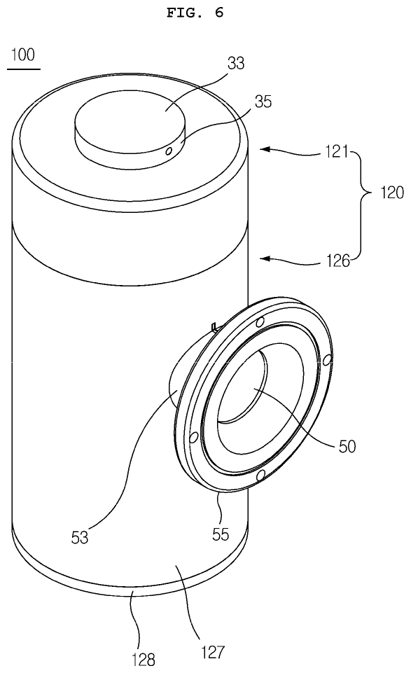

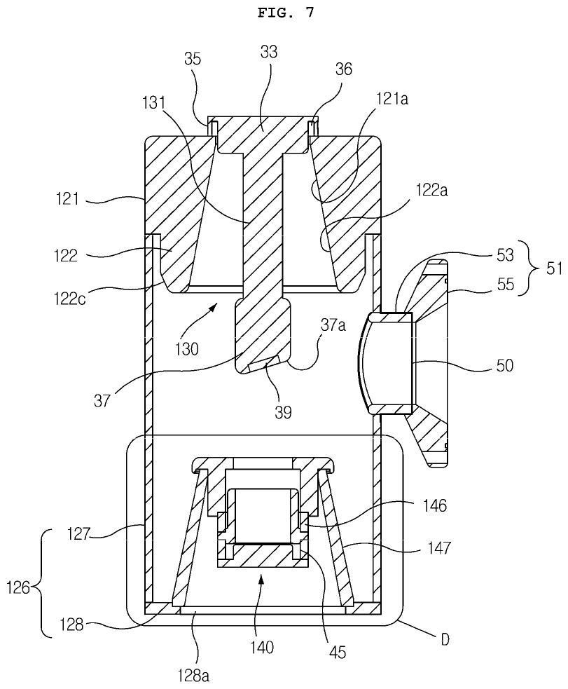

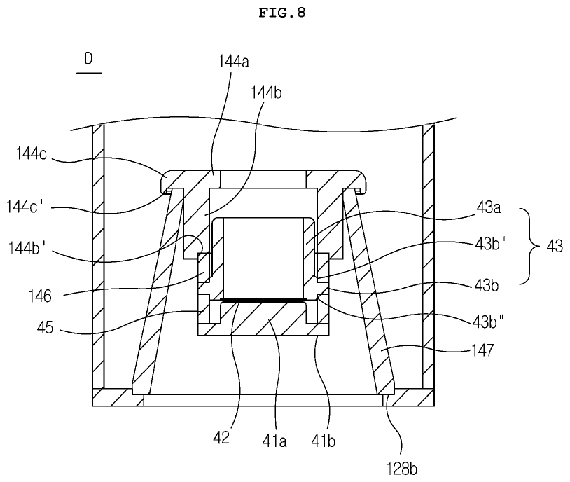

FIG. 6 is an external perspective view of the X-ray source 100 according to a second modification of the preferred embodiment of the present invention; FIG. 7 is a longitudinal cross-sectional view of FIG. 6; and FIG. 8 is an enlarged cross-sectional view of a part D of FIG. 7.

The X-ray source 100 according to the second modification of this embodiment may be configured in a dual power supply manner in which the anode voltage and cathode voltage represent positive and negative potentials, respectively. For example, the anode voltage may be +60 kV, and the cathode voltage may be −60 kV.

When comparing FIG. 7 with FIG. 2, although the X-ray source 100 according to the second modification has almost the same structure as the X-ray source 10 according to the first modification, they are different in that since the anode voltage is relatively low, the dielectric strength required for the first housing 21 is relatively small. Therefore, the length of the housing is relatively short, and the cathode electrode 41 is disposed inside the second housing 126, so that the distance between the target 39 and the cathode electrode 41 may be maintained. To this end, a third insulating spacer 147 of tube shape may be added inside the second housing 126.

Hereinafter, when the structure and function of the X-ray source 10 according to the second modification are the same as those of the X-ray source according to the first modification, the same reference numerals are assigned, and detailed descriptions thereof are omitted.

Referring to FIGS. 6 and 7, the X-ray source 100 may include a housing 120 that forms an external appearance.

The housing 120 may include a first housing 121 with an anode electrode portion 130 and a second housing 126 with a cathode electrode portion 140. The first housing 121 may be made of an insulating material, for example, a ceramic material, and the second housing 126 may be made of a metal material. Compared with the first modification, the first housing 121 may have a relatively short length (height).

A sleeve 122 may be formed to extend downward the inside of the second housing 126 in the lower end of the first housing 121. The sleeve 122 may be made of the same material as the first housing 121.

The inner surface 121a of the first housing 121 and the inner surface 122a of the sleeve 122 may have a skirt shape in which inner diameter increases as it moves downward.

The outer surface 122b of the sleeve 122 may be spaced apart from the cylindrical tube 127 of the second housing 126. An inclined surface 122c may be formed outside the lower end of the sleeve 122. The inclined surface 122c may have a funnel or dish shape that gradually narrows with the inner surface of the cylindrical tube 127 as it moves toward the first housing 121.

The second housing 126 may include a cylindrical tube 127 and a bottom plate 128. A through hole 128a may be formed in the center of the bottom plate 128.

Referring to FIG. 7, the X-ray source 100 may include an anode electrode portion 130.

The anode electrode portion 130 may be disposed at the center of the inner surfaces of the first housing 121 and the sleeve 122.

The anode electrode portion 130 may include an anode electrode 131, and a support bundle 33 and a target installation bundle 37 formed at the upper end and the lower end of the anode electrode 131, respectively.

The anode electrode 131 may be covered with the first housing 121 and the sleeve 122.

The anode electrode 131 of the dual power supply may be relatively shorter than the length (height) of the anode electrode 31 of the single power supply.

A support 35 may be included on the outer peripheral surface of the support bundle 33. The support 35 may be L-shaped and include a horizontal support 35a and a vertical support 35b. A space 36 may be formed to allow thermal expansion between the vertical support 35b and the outer peripheral surface of the support bundle 33.

The lower surface 37a of the target installation bundle 37 is an inclined surface to face toward the window 50, in which the target 39 may be bonded to this inclined surface.

Referring to FIGS. 7 and 8, the X-ray source 100 may include a cathode electrode portion 140. The cathode electrode portion 140 may be disposed inside the second housing 126.

The cathode electrode portion 140 may include a cathode electrode 41. The cathode electrode 41 may be disposed inside the housing 20.

The cathode electrode 41 has a convex shape and may include a cathode body 41a and a cathode flange 41b. An emitter (not shown) may be disposed on the upper surface of the cathode body 41a.

The cathode electrode portion 140 may include a gate electrode 42 provided on the upper surface of the cathode body 41a. The gate electrode 42 may have a mesh shape.

The cathode electrode portion 140 may include a focus portion 43.

The focus portion 43 may include a focus tube 43a and a focus flange 43b. The gate electrode 42 may be bonded to the lower end of the focus tube 43a. A first step 43b′ may be formed to be downward-concave on the upper surface of the focus flange 43b. A second step 43b″ may be formed to be upward-concave on the lower surface of the focus flange 43b.

The cathode electrode portion 140 may include a focus electrode 144.

The focus electrode 144 may include a focus electrode hollow plate 144a. An inner diameter of the focus electrode hollow plate 144a may be the same as or slightly larger than that of the focus tube 43a.

The focus electrode 144 may include a focus electrode side wall 144b. The focus electrode side wall 144b may extend downward from the lower surface of the focus electrode hollow plate 144a. The inner diameter of the focus electrode side wall 144b may be larger than the outer diameter of the focus tube 43a. The focus electrode side wall 144b may be inserted into the outer peripheral surface of the focus tube 43a. An upwardly concave step 144b′ may be formed in the lower end of the focus electrode side wall 144b.

The focus electrode 144 may include a support flange 144c. The support flange 144c may protrude outward from the outer peripheral surface of the focus electrode hollow plate 144a. A locking protrusion 144c′ may be formed at the end of the support flange 144c. The locking protrusion 144c′ may protrude downward from the end of the support flange 144c.

The cathode electrode portion 140 may include a first insulating spacer 45. The first insulating spacer 45 may be provided between the cathode electrode 41 and the focus portion 43. That is, the first insulating spacer 45 may be provided between the cathode flange 41b and the second step 43b″. The first insulating spacer 45 separates the cathode electrode 41 and the gate electrode 42 to cause them to be electrically insulated from each other.

The cathode electrode portion 140 may include a second insulating spacer 146. The second insulating spacer 146 may be provided between the focus electrode 144 and the focus portion 43. That is, the bottom of the second insulating spacer 146 may be provided between the first step 43b′ and the step 144b′. The second insulating spacer 146 separates the focus portion 43 and the focus electrode 144 to cause them to be electrically insulated from each other.

The X-ray 100 include source may a third insulating spacer 147. The third insulating spacer 147 may be provided between the focus electrode 144 and the bottom plate 128. That is, the third insulating spacer 147 may be provided to extend between the locking protrusion 144c′ and the step 128b of the bottom plate 128. The third insulating spacer 147 may insulate the cathode electrode 41 from the second housing 126 while simultaneously fixing the cathode electrode portion 140 to the second housing 126. The third insulating spacer 147 may have a skirt shape in which diameter increases as it moves from the top to the bottom. Accordingly, the third insulating spacer 147 may introduce residual charges inside the housing into the second housing 127 made of metal.

The cathode electrode portion 140 may be joined to these components to form an assembly. The cathode electrode portion 140 of such an assembly structure may be configured so that the lower end of the third insulating spacer 147 is joined into the step 128b of the bottom plate 128.

The X-ray source 100 may include a window 50.

The window 50 may be provided on the flange portion 51. The flange portion 51 may include a horizontal pipe 53 and a flange 55. The window 50 may be provided at the interface between the horizontal pipe 53 and the flange 55.

Meanwhile, the distance between the target 39 and the cathode electrode 41 may be fixed to form an electric field.

In the case of the X-ray source 100 in which negative and positive potentials are applied to the cathode electrode electrode 41 and the anode portion 130, respectively, the anode voltage is relatively low, so that the dielectric resistance required for the first housing 21 is relatively small. Therefore, since the cathode electrode 41 is placed inside the housing 120, the distance between the target 39 and the cathode electrode 41 may be maintained constant, by reducing the length of the anode electrode 131 and the first housing 121 and increasing the length (or height) of the third insulating spacer 147.

For example, when comparing FIGS. 2 and 7, the first housing 121 and the anode electrode 131 of the X-ray source 100 of FIG. 7 may be formed to be shorter in length than the first housing 21 and the anode electrode 31 of the X-ray source 10 of FIG. 2, but the second housing 126 of the X-ray source 100 of FIG. 7 may be formed to be longer in length than the second housing 26 of the second X-ray source 10 of FIG. 2.

Any or other embodiments of the present invention described above are not exclusive or distinct from each other. In certain embodiments or other embodiments of the present invention described above, each configuration or function may be used in combination or combined.

It is obvious to those skilled in the art that the present invention can be embodied in other specific forms without departing from the spirit and essential features of the present invention. The above detailed description should not be construed as restrictive in any respect and should be considered illustrative. The scope of the present invention should be determined by reasonable interpretation of the appended claims, and all changes within the equivalent scope of the present invention are included in the scope of the present invention.

### DESCRIPTION OF NUMERALS

10: X-ray source 20, 120: housing
21, 121: first housing 22, 122: sleeve
25: joint portion 26, 126: second housing
27, 127: cylindrical tube 28, 128: bottom plate
30, 130: anode electrode portion 31, 131: anode electrode
33: support bundle 35: support
37: target installation bundle 39: target
40: cathode electrode portion 41: cathode electrode
42: gate electrode 43: focus portion
44, 144: focus electrode 45: first insulating spacer
46,146: second insulating spacer 50: window
51: flange portion 53: horizontal pipe
55: flange 100: X-ray source
147: third insulating spacer

1. An X-ray source, comprising:
an anode electrode;
a target electrically connected to the anode electrode;
a first housing of an insulating material accommodating at least a part of the anode electrode;
an emitter formed opposite to the target;
a cathode electrode electrically connected to the emitter; and
a second housing of a conductive material forming an X-ray tube together with the first housing.

2. The X-ray source of claim 1, wherein the first housing has a larger inner diameter as it moves from the anode electrode to the cathode electrode.

3. The X-ray source of claim 1, further comprising:
a flange provided on an outer surface of the second housing; and
a window formed on the flange.

4. The X-ray source of claim 1, wherein the second housing further comprises an insulating spacer; and
the cathode electrode is fixed to the insulating spacer.

5. The X-ray source of claim 4, wherein the cathode electrode is disposed inside or outside the second housing. cm 6. The X-ray source of claim 1, wherein the size of the anode voltage applied to the anode electrode is proportional to the length of the first housing.
